(19) United States
(12) Patent Application Publication
(10) Pub. No.: US 2017/0231170 A1
(43) Pub. Date: Aug. 17, 2017

(54) Weed Blocking Mini Conservatory

(71) Applicant: Stephanie McCarthy, Harpers Ferry, WV (US)

(72) Inventor: Stephanie McCarthy, Harpers Ferry, WV (US)

(21) Appl. No.: 15/419,930

(22) Filed: Jan. 30, 2017

Related U.S. Application Data
(63) Continuation of application No. 62/295,119, filed on Feb. 14, 2016.

(51) Int. Cl. A01G 9/16; A01G 13/02; A01G 13/00; A01G 9/14; A01G 9/24

(52) U.S. Cl. CPC A01G 9/16; A01G 9/14; A01G 9/24; A01G 9/1407; A01G 13/00; A01G 13/0237; A01G 13/0268; A01G 13/0293; A01G 2013/002; A01G 13/0281

(57) ABSTRACT

The Weed Blocking Mini Conservatory is a device which blocks weed, plant, root, and some predator encroachment. When connected to the light penetrating top, the invention allows a protected area for photosynthesis, seed and rooting cultures, with containers, mediums, and associated accessories and garden storage. The device functions as a hollow, washable, durable container in which both living and nonliving items can be enclosed. Its structure blends harmoniously with architecture and outdoor environments. It is safe for use around humans and pets. It is also adaptable to large scale garden use.

Government support statement: this invention was not made with Government support.

### BACKGROUND

The present invention is in the technical field of horticulture. More particularly, the present invention is a device which blocks, controls, and kills encroaching weed plants and roots with a light blocking barrier; blocks some predators on outdoor substrate; and when connected to the light penetrating top, allows for photosynthesis, enhanced seed and root culturing, plant habitation; and general storage in a hollow, washable, durable interior.

Plant habitats such as mini greenhouses, terrariums, and cloches, are desirable for protecting living plants and seeds from cold temperatures, drying wind, animals, birds, large insects, and general predation; allowing for storage; while allowing for photosynthesis in a hollow, light penetrating interior.

### Short Comings of What is Currently Used:

Portable plant protection covers for outdoors use do not make it possible to block encroaching weeds and pests from beneath because they do not include a weed blocking component; and allow light to reach the base substrate. The inventions may be made of flimsy sheeting vulnerable to high wind, precipitation, and predators. They may be one portable piece which will protect the top of a containerized plant, without protecting a plant container itself from cold temperatures.

The Wardian orchid and fern case raised humidity levels during transportation or indoor habitation of plants. The invention is a fragile portable assemblage generally of glass, metal, lead, or wood, intended for indoor use. The device is not intended for storage of other devices such as hoses, pottery, hand tools, statuary, water features, pumps, and large container plants outdoors. The device is not intended for outdoor use except in limited periods during transport.

Terrariums are indoor plant devices used to control humidity while allowing photosynthesis. The invention is not intended for usage as a storage device for garden hoses, pottery, hand tools, statuary, water features, pumps, or container plants outdoors. The bottom may hold growing mediums, plant, and water directly in the hollow interior which does not make it possible to regularly remove the contents and wash the invention.

Cold frames and Hoop houses, when portable create a border bounding a ground holding space where seeds are planted directly into the substrate where they have protection from external elements. They do not include a weed blocking component and are specifically intended to promote growth within, which allows for encroachment of weeds and predators on the substrate. The top is hinged onto the top of a standard cold frame and can not be used separately from the device.

Mini greenhouses are assemblages of a plurality of flimsy, flexible sheeting, or fragile pieces such as glass, acrylic, polyethylene film, PVC, fabric, metal or wood, requiring complex assembly, which diminishes portability. A weed blocking component is not a characteristic of mini greenhouse inventions. Mini and portable greenhouses are susceptible to damage by wind and ice.

Inflatable outdoor habitats are susceptible to wind, heavy precipitation, punctures, and slow leaks which limit durability and weed blocking applications.

Sheds, pet habitats, and playhouses are not designed to encourage photosynthesis over the largest part of the hollow interior. They do not allow for drainage of water through the bottom.

Portable gazebo inventions do not have sufficient side, top, and floor coverage or density to provide shelter to a plurality of objects in adverse weather.

### BRIEF SUMMARY OF THE PRESENT INVENTION

The Weed Blocking Mini Conservatory is a device with a component which makes it possible to block, control, and kill plants by functioning as a barrier to light. The invention will also block some animal and insect predators. When connected to the light penetrating top, the invention allows for photosynthesis, enhanced seed and root culturing, and storage in a hollow body. The reinforcement ribs which look like window, door, mullion, and sashes function to strengthening the rigid surfaces and blend easily with large scale architecture. The invention is protective, washable, durable, affordable material that is adaptable to large scale garden uses.

### BRIEF DESCRIPTION OF THE DRAWINGS

FIG. 1 shows a front view of a Weed Blocking Mini Conservatory

FIG. 2 shows a profile of a Weed Blocking Mini Conservatory

FIG. 3 shows a rotated side view of a Weed Blocking Mini Conservatory

FIG. 4 shows a rotated side view of a Weed Blocking Mini Conservatory with access holes

FIG. 5 shows a side view of a Weed Blocking Mini Conservatory with collar

REFERENCE NUMERALS IN THE DRAWINGS

| | | | |
|---|---|---|---|
| 10 | top/light penetrating top | 12 | reinforcement ribs |
| 14 | fastener | 16 | bottom/weed blocking bottom |
| 18 | vents | 20 | drainage |
| 22 | anchor hole | 24 | collar |
| 30 | handle | 32 | access hole |
| 40 | access hole extension | | |

### DETAILED DESCRIPTION OF THE INVENTION

The aforementioned and other needs described in Short comings of what is currently used are fulfilled by one or more aspects of the Weed Blocking Mini Conservatory.

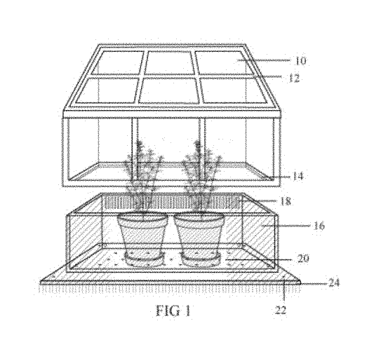

In drawing FIG. 1 of the Weed Blocking Mini Conservatory the light penetrating 10 top and weed blocking 16 bottom are separated to show access to the hollow interior.

When 10 and 16 are joined, and in some cases separated, the invention makes it possible but is not limited to functioning as a habitat capable of allowing photosynthesis. A plurality of holes, access holes, and indentations, make it possible for air circulation, drainage, and anchoring while controlling encroaching plants and pests at substrate level. The invention can be used with 10 top and 16 bottom separated or joined for flexible use on patios, rooftops, cities, yards, gardens, or indoors. Some embodiments of the present invention may stack easily and nest together in storage. 14 is edging; 18 are vents; 20 drainage. 22 are anchoring holes to make it possible to stabilize the conservatory to the substrate with, but not limited to, tent hardware, according to one embodiment of the invention.

The 10 top and 16 bottom of the present invention may be comprised of a plurality of pieces and materials without limit and are attached in such a way to allow simplicity of assembly and use, with light penetration at the top, and weed blocking function at the bottom. The invention may be made of, but is not limited to, flexible and durable molded plastic in varying densities and colors.

The 10 top and 16 bottom may have additives or treatments including but not limited to UVL protection to lengthen the life of the invention in regular outdoor or artificial light.

The 10 top and 16 bottom are safe for human or pet use.

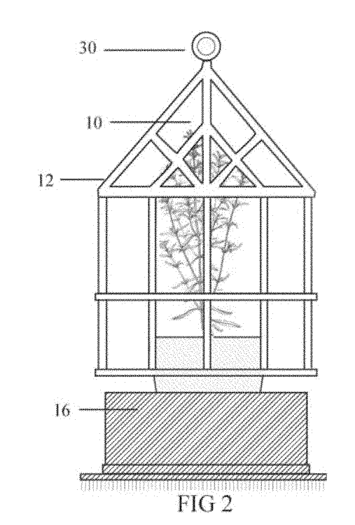

FIG. 2 shows a profile of a Weed Blocking Mini Conservatory with the 10 light penetrating top with a 30 handle, according to one embodiment of the disclosure. Referring again to FIG. 2, reinforcement ribs 12 function to add strength to the rigid sides while allowing for maximum light penetration over the greater part of the surface. In more detail, referring again to reinforcement ribs 12, window mullion, sash, and all slopes of the invention, function to add strength, shed water and blend when used near traditional architecture and outdoor environments. The reinforcement ribs fashioned like window and door architecture 12 of the device prevents the invention from being an eyesore in regular outdoor usage. The surface of 16 bottom functions to blend with architecture and natural elements, which may be, but are not limited to, stone, brick, terra cotta, aged metal, and habitat coloration and texture surfacing treatments.

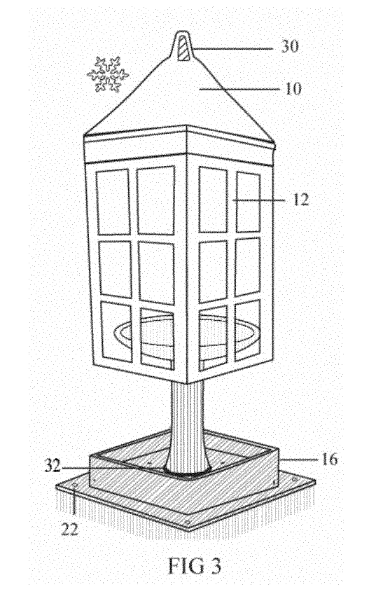

FIG. 3 shows a rotated side view of the Weed Blocking Mini Conservatory with a 32 access hole on the 16 bottom. The 22 anchoring holes can be combined with, but are not limited to, tent hardware to secure conservatory to the substrate. The 10 light penetrating top functions to protect, reduce effect of freezing temperatures, and allow access for the maintenance of a water feature, living plant material, or a plurality of objects and devices; examples may include container plants, toys, pottery, and tools. The 10 light penetrating top easily attaches to 16 bottom in the manner of a polyethylene or similar plastic storage box and lid systems in one embodiment of the invention, or 10 may overlap parts of the 16 bottom according to embodiments of the present invention. Still referring to the 10 top and 16 bottom, the construction may include UVL and other additives for long life.

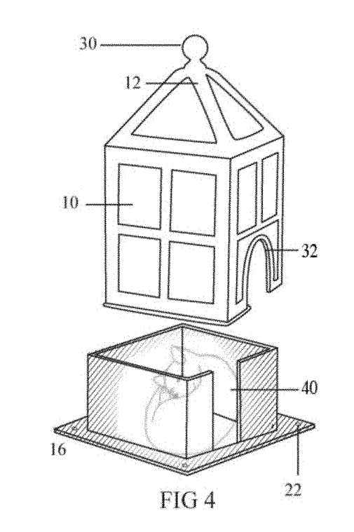

FIG. 4 shows the 10 light penetrating top with 12 reinforcement ribs, and 30 handle, separate from the 16 weed blocking bottom to show a hollow interior. 32 access hole and 40 access hole extension in the rigid sides according to one embodiment of the disclosure, make it possible to temporarily shelter a pet in light penetrating hollow interior. Non toxic materials make the invention a weather proof conservatory for small animals, or container plants and water features, according to scale, structure, and plurality of holes, in embodiments of the disclosure.

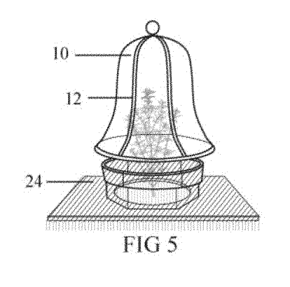

FIG. 5 shows the 10 light penetrating top sloping in multiple directions with 12 reinforcement ribs fashioned like conservatory architecture, for strength and landscape blending; and a rounded handle according to one embodiment of the invention. The bottom has a 24 extended collar which makes it possible to plant, seed, or root directly into the substrate while blocking weed and certain insect encroachment, according to one embodiment of the disclosure.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

Having herein described my invention, for a Weed Blocking Mini Conservatory, I claim:

1) a two piece structure for the protection and housing of a plurality of objects including containerized plants and plant containers, statuary, tools, water features, pumps, among other utilitarian and decorative items, in a safe and durable manner, making it possible for photosynthesis and sprouting to occur in the hollow interior without weeds or pests, or damage from wind, cold temperatures, or harsh weather

2) a light blocking bottom component making it possible to block, control, and kill encroaching plants, roots, and block some predators from the substrate;
which can be connected to a light penetrating top

3) reinforcement ribs which strengthen the sides, aid in shedding water, and which form window and door structures for blending into environments when in regular use outdoors
